(19) United States
(12) Patent Application Publication
(10) Pub. No.: US 2026/0211921 A1
(43) Pub. Date: Jul. 23, 2026

(54) CONTEXT-AWARE FIELD BINDING FOR TEST DATA

(71) Applicant: SAP SE, Walldorf (DE)

(72) Inventor: Prashant TELKAR, Bangalore (IN)

(21) Appl. No.: 19/035,037

(22) Filed: Jan. 23, 2025

(51) Int. Cl. G06F 16/334; G06F 16/22; G06F 16/353; G06F 40/30

(52) U.S. Cl. CPC G06F 16/3347; G06F 16/2237; G06F 16/353

(57) ABSTRACT

A system and method include determination of input fields of automation scripts, acquisition of metadata of database object fields, prompting of a text generation model using a chain-of-thoughts prompt, the input fields and the acquired metadata to determine mappings between the input fields and the database object fields, prompting of an embedding model to generate embeddings based on each input field, associating each embedding with each mapping that includes the input field on which the embedding was generated, identification of a first input field of an automation script, prompting of a second embedding model to generate a first embedding based on the first input field, searching for embeddings similar to the first embedding, identification of a candidate mapping associated with each of the embeddings, and determination of a first database object field to bind to the first input field based on the identified candidate mappings.

### BACKGROUND

Modern enterprises generate and store vast amounts of data. Software applications allow users to review, manage and analyze the data to execute enterprise processes. Due to their importance to an enterprise, these applications undergo significant testing prior to deployment. Such testing may comprise the execution of test scripts on sample data.

Creating sample data which is adequate for testing is a complex, labor-intensive, and error-prone task. Traditional manual methods for generating such data lead to inconsistencies that compromise the integrity of testing. Current techniques rely on predefined rules and templates, which can limit the variability and complexity of the generated data and thereby fail to address the nuanced requirements of enterprise systems.

Some systems allow the creation of test data containers which specify particular fields of database objects and values of the fields to be used in testing. Users therefore rely on the system to accurately determine bindings between database object fields and user interface (UI) input fields specified in test scripts. Determination of the bindings typically consists of identifying database object fields and UI input fields which have matching text labels.

However, the text labels of corresponding fields may not match exactly.

Conversely, text labels of incompatible fields may be identical. Both conditions, as well as variations in naming conventions, abbreviations, and typographical errors, may call for manual user intervention. Since most users do not possess the technical expertise required to determine correct bindings, manual intervention is time-consuming, prone to errors, inconsistent, and harmful to the overall user experience. This hybrid automated/manual process is not scalable and therefore ill-suited to handling the increasing volume and complexity of test data.

What is needed are systems to efficiently determine bindings between database object fields and UI input fields.

### BRIEF DESCRIPTION OF THE DRAWINGS

FIG. 1 illustrates a system to determine bindings between database object fields and UI input fields according to some embodiments.

FIG. 2 is a flow diagram of a process to generate a vector database of mappings between database object fields and UI input fields according to some embodiments.

FIG. 3 illustrates a system to generate test scripts according to some embodiments.

FIG. 4 illustrates a system to define test data containers according to some embodiments.

FIG. 5 is a user interface of a test data container manager application according to some embodiments.

FIG. 6 illustrates prompting of a text generation model to determine mappings between database object fields and UI input fields according to some embodiments.

FIG. 7 is a flow diagram of a process to determine mappings between database object fields and UI input fields according to some embodiments.

FIG. 8 illustrates a system to generate a vector database of mappings between database object fields and UI input fields according to some embodiments.

FIG. 9 is a flow diagram of a process to determine bindings between database object fields and UI input fields according to some embodiments.

FIG. 10 illustrates a system to determine bindings between database object fields and UI input fields according to some embodiments.

FIG. 11 is a user interface of a test process manager application showing process steps of a test script according to some embodiments.

FIG. 12 is a user interface of a test process manager application showing actions of a test script process step according to some embodiments.

FIG. 13 is a user interface of a test process manager application showing fields of test script process steps and candidate fields of a test data container according to some embodiments.

FIG. 14 illustrates mappings between database object fields and UI input fields according to some embodiments.

FIG. 15 is a user interface of a test process manager application showing bindings between fields of test script process steps and fields of a test data container according to some embodiments.

FIG. 16 is a diagram of a cloud-based implementation according to some embodiments.

### DETAILED DESCRIPTION

The following description is provided to enable any person in the art to make and use the described embodiments. Various modifications, however, will be readily-apparent to those in the art.

Embodiments may efficiently and accurately determine bindings between database object fields and UI input fields. Embodiments may significantly reduce the need for manual intervention, reduce dependency on exact label matches, streamline the binding process, enhance user experience, and ensure the system scalability as data volumes grow.

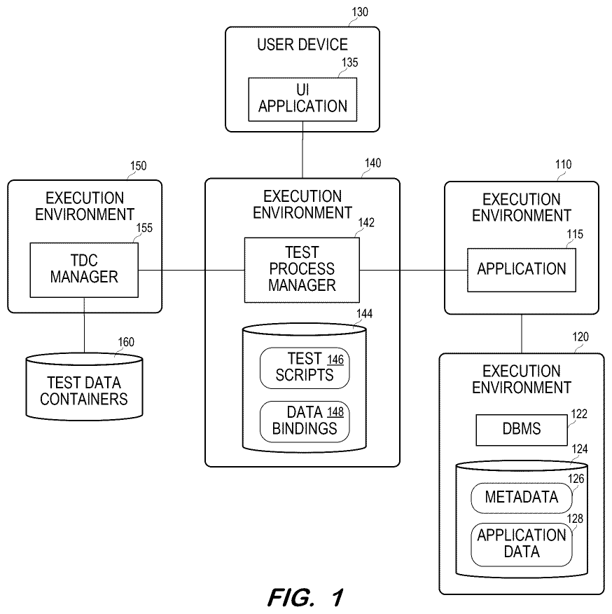

FIG. 1 illustrates a system to determine bindings between database object fields and UI input fields according to some embodiments. Each of the illustrated components may be implemented using any suitable combination of local, on-premise, cloud-based, distributed (e.g., including distributed storage and/or compute nodes) computing hardware and/or software that is or becomes known. Each component described herein may be executed by one or more physical and/or virtualized servers. In particular, each depicted execution environment may comprise one or more physical servers, virtual machines, clusters of a container orchestration system, or other implementation providing an operating system, services, I/O, storage, libraries, frameworks, etc. to applications executing therein.

Two or more components of FIG. 1 may be co-located. In some embodiments, two or more components are implemented by a single computing device. One or more components may be implemented by a cloud service (e.g., Software-as-a-Service, Platform-as-a-Service). A cloud-based implementation of any components of FIG. 1 may apportion computing resources elastically according to demand, need, price, and/or any other metric.

Execution environment 110 executes application 115, which may provide any one or more functions to users (not shown). During operation, application 115 accesses data provided by database management system (DBMS) 122 executing within environment 120. The data is stored within data storage system 124 as application data 128. Data storage system 124 also stores object metadata 126 describing the structure (e.g., fields, field data types, field data constraints) and interrelationships (i.e., the schema) of database objects. Application data 128 comprises data of specific instances of such database objects. For example, each record of a sales order table of application data 128 may include data values of a respective instance of a sales order object.

A user may operate user device 130 to execute UI application 135 and control UI application 135 to initiate testing of application 115. For example, user device 130 may access test process manager application 142 of execution environment 140 via a Web browser and download a client UI application of test process manager 142. A user may interact with UI application 135 to request testing of application 115. Such a request may specify test scripts to be executed and test data to be used.

In response to such a request, test process manager 142 retrieves a test script 146 stored in data storage system 144. Test scripts 146 may be generated by recording interactions with UI entities of application 115 as is known in the art. Test process manager 142 executes the retrieved test script 146 to control application 115 executing in environment 110. Such control may comprise executing UI actions specified by the retrieved test script 146 on UIs of application 115 and monitoring the results. The UI actions of a test script 146 may include inputting data values to specified UI input fields of application 115. These data values may be determined from test data stored in test data containers 160.

A user may operate test data container manager application 155 of execution environment 150 to define test data containers 160. A test data container 160 may specify one or more database object fields of each of one or more data objects defined in metadata 126. A test data container 160 may also specify metadata such as an identifier of an application (e.g., application 115) and a field of use (e.g., manufacturing). A test data container 160 includes one or more variants, or test data instances. A test data instance includes a set of values, where each value corresponds to one of the database object fields of the test data container 160.

Since test scripts 146 are generated by recording interactions with UI entities and the database object fields of a test data container 160 are taken from metadata 126 of application 115, the data value of a test data instance which should be input to a particular UI input field is specified in a test script 146 may be unclear. Data bindings 148 are therefore generated as described herein to provide mappings between database object fields of a test data container 160 and UI input fields of a test script 146. Data bindings 148 are determined based on a pre-generated vector database as will be described below.

As described above, a test script 146 may include an action to populate a UI input field of application 115. To execute this action, test process manager 142 uses data bindings 148 to determine a database object field corresponding to the UI input field. Next, test process manager 142 populates the UI input field with a value of the database object field from a test data instance.

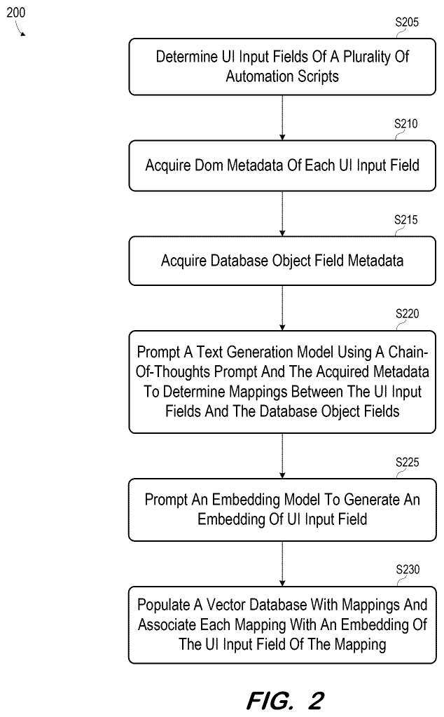

FIG. 2 comprises a flow diagram of process 200 to generate to generate a vector database of mappings between database object fields and UI input fields according to some embodiments. The vector database may be used to determine data bindings between database object fields and UI input fields as will be further described below. The vector database may be generated using generative artificial intelligence (AI) technology. Advantageously, and since the vector database is pre-generated prior to determination of data bindings, the determination of data bindings does not require additional time-consuming and resource-consumptive processing by a generative AI model.

Process 200 and the other processes described herein may be performed using any suitable combination of hardware and software. Software program code embodying these processes may be stored by any non-transitory tangible medium, including a fixed disk, a volatile or non-volatile random-access memory, a DVD, a Flash drive, or a magnetic tape, and executed by any number of processing units, including but not limited to processors, processor cores, and processor threads. Such processors, processor cores, and processor threads may be implemented by a virtual machine provisioned in a cloud-based architecture. Embodiments are not limited to the examples described below.

At S205, UI input fields of a plurality of automation scripts are determined. In some embodiments, all existing automations scripts associated with a given application are collected and all UI input fields specified in the collected automation scripts are determined. Also collected with each determined UI input field at S205 may be its text label, its scope (e.g., purpose and functionality, data type, length, allowed values, validation rules, contextual behavior, localization), the enterprise functional area to which the UI input field belongs, the name of the process from which it arose, and link to its application.

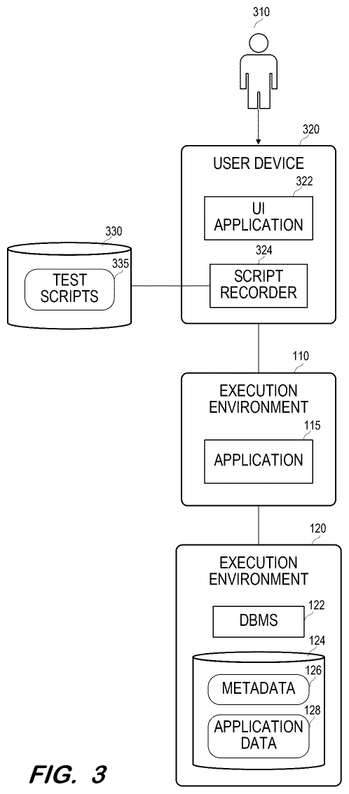

FIG. 3 illustrates a system to generate test automation scripts according to some embodiments. Execution environment 110 executes application 115 and execution environment 120 executes DBMS 122 as described above. User device 320 includes UI application 322 for transmitting requests to and receiving responses from application 115.

User device 320 also includes script recorder 324. Prior to process 200, user device 320 may execute script recorder 324 to record input of user 310 to UI application 322. The recorded user input may include selection of UI controls, selection of hyperlinks, input of data values into UI input fields, etc. The recorded user input may represent actions taken by user 310 to test application 115.

The recorded user input is formatted into a re-playable test script which may be stored in storage system 330 as test scripts 335. Storage system 330 may be a shared system for storing test scripts 335 generated from interactions with application 115 by multiple users and user devices (not shown). Accordingly, S205 may comprise acquiring test scripts 335 from storage system 330 and from all other similar storage systems storing test scripts associated with application 115 (and/or one or more other applications) and generated prior to process 200, and determining all UI input fields mentioned in the test scripts.

Document object model metadata associated with each determined UI input field is determined at S210. In Web development, DOM (Document Object Model) properties assist in rendering and managing a UI. Each UI input field is a UI control associated with DOM properties. At S210, the DOM properties for each UI input field may be determined using its text label and the link to its application. The determined DOM properties may include but are not limited to an xpath, data type, technical name, length, and field type.

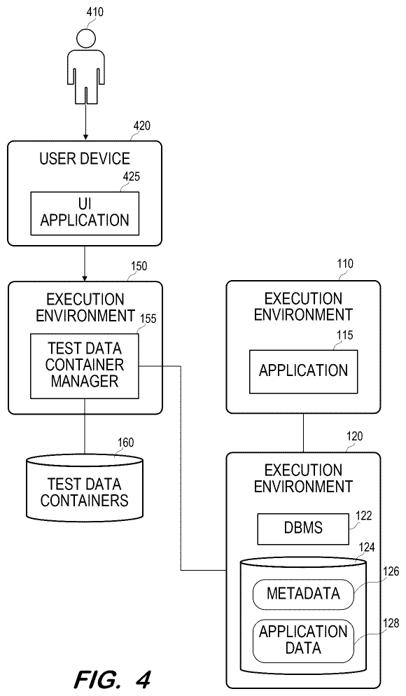

Database object field metadata is acquired at S215. The database object field metadata may comprise database object fields of pre-defined test data containers. FIG. 4 illustrates a system to generate test data containers according to some embodiments. Prior to process 200, user 410 operates UI application 425 of user device 420 to communicate with test data container manager application 155 of execution environment 150. Based on the communication, test data container manager 155 accesses database object metadata 126 and creates test data containers 160. Each of test data containers 160 includes a subset of database object fields and test data instances, with each test data instance including values for one or more of the subset of database object fields.

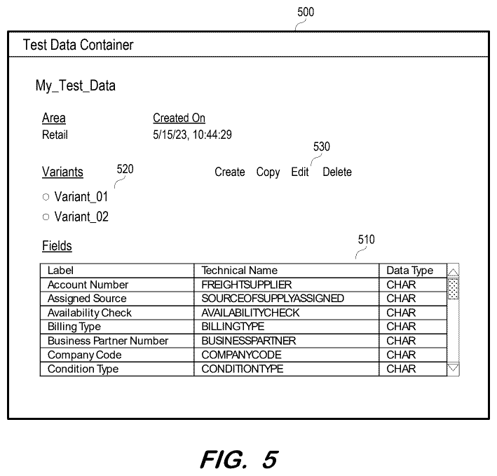

FIG. 5 illustrates user interface 500 of test data container manager application 155 according to some embodiments. User interface 500 presents information related to a test data container named My_Test_Data associated with the enterprise function area Retail. Fields 510 comprise a list of database object fields selected by a user for inclusion in the test data container. Fields 510 may comprise a subset of database object fields of one or more database objects specified in metadata 126.

User interface 500 includes two variants 520. Each variant 520 is a test data instance as described above. That is, each variant 520 specifies a data value for each of one or more of fields 510. Variants of the test data container may be created, edited, copied and deleted using controls 530.

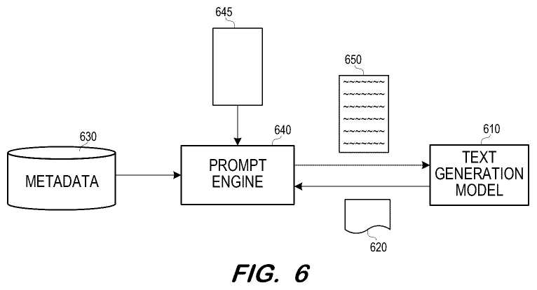

Returning to process 200, a text generation model is prompted at S225 using a chain-of-thoughts prompt and the metadata acquired at S210 and S215 to determine mappings between the UI input fields and the database object fields. FIG. 6 illustrates prompting of text generation model 610 to determine mappings 620 between database object fields and UI input fields based on metadata 630 according to some embodiments of S225.

Text generation model 610 may comprise any one or more neural networks trained to generate text based on input text. Text generation model 610 may be implemented by, for example, executable program code, a set of hyperparameters defining a model structure and a set of corresponding weights, or any other representation of an input-to-output mapping which was learned as a result of the training. According to some embodiments, model 610 is a Large Language Model (LLM) conforming to a transformer architecture. Generally, each layer includes nodes which receive input, change internal state according to that input, and produce output depending on the input and internal state. The output of certain nodes is connected to the input of other nodes to form a directed and weighted graph. The weights as well as the functions that compute the internal states are iteratively modified during training.

A transformer architecture may include, for example, embedding layers, feedforward layers, recurrent layers, and attention layers. An embedding layer creates embeddings from input text, intended to capture the semantic and syntactic meaning of the input text. A feedforward layer is composed of multiple fully-connected layers that transform the embeddings. Some feedforward layers are designed to generate representations of the intent of the text input. A recurrent layer interprets the tokens (e.g., words) of the input text in sequence to capture the relationships between the tokens. Attention layers may employ self-attention mechanisms which are capable of considering different parts of input text and/or the entire context of the input text to generate output text.

Non-exhaustive examples of text generation model 610 include GPT-4, LLaMA, T5, BERT or the like. Model 610 may be publicly available or deployed within a trusted landscape.

Metadata 630 comprises the metadata acquired at S205 and S210. Metadata 630 is input to prompt engine 640, which uses metadata 630 and prompt template 645 to generate prompt 650. In some embodiments, prompt 650 comprises a system prompt consisting of prompt template 645 and a user prompt consisting of metadata 630. Prompt 650 is intended to prompt text generation model 610 using chain-of-thoughts prompting to determine mappings between the UI input fields and the database object fields represented in metadata 630. Instead of asking a model to directly produce a final answer, chain-of-thoughts prompting guides the model to solve a problem in incremental steps rather than directly generating a final response.

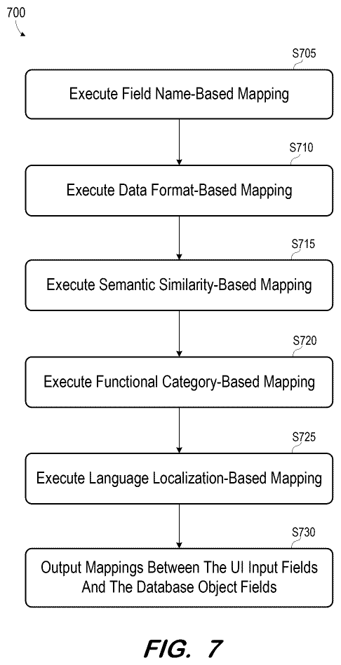

FIG. 7 is a flow diagram of process 700 which may be executed by model 610 in response to chain-of-thoughts prompt 650 to determine mappings between the database object fields and UI input fields of metadata 630 according to some embodiments.

In one example, prompt 650 includes the following text to prompt execution of field name-based mapping at S705: “Map the database object fields and the UI input fields based on their respective field names. If field names differ, map the database object fields and the UI input fields by identifying common patterns or abbreviations. Generate a list of potential mappings.”

Prompt 650 may include the following text to prompt execution of data format-based mapping at S710: “Map the database object fields and the UI input fields based on data type compatibility, ensuring that mapped fields support the same type of data (e.g., integer, string, date).”

Model 610 then performs semantic similarity-based mapping at S715, based on the following prompt text: “Map the database object fields and the UI input fields based on their semantic similarity and context, using keywords related to field functions, such as ‘invoice,’ ‘date,’ ‘amount,’ and ‘status.’”

At S720, model 610 executes functional category-based mapping in response to the prompt text: “Map the database object fields and the UI input fields based on their associated functional category (e.g., Sales, Finance, Service).” Next, at S725, language localization-based mapping is executed based on prompt text such as “Map the database object fields and the UI input fields based on localizations or translations of common terms (e.g., matching ‘Amount’ with ‘Montant’ for French localization).”

The thusly-determined mappings 620 between database object fields and the UI input fields are output by model 610 at S730. The mappings may map a given UI input field to zero, one, or more database object fields and may map a given database object field to zero, one, or more UI input fields. Each mapping may be represented by a table record which may include a UI input field, a database object field, technical identifiers of each field and, in some embodiments, additional metadata such as a data type (e.g., CHAR), an enterprise area (e.g., Finance) and an enterprise scenario (e.g., J59) associated with the database object field of the mapping.

Returning to process 200, an embedding model is prompted at S225 to generate embeddings of each UI input field acquired at S210. The embedding model is pre-trained to generate a multi-dimensional numerical vector (i.e., an embedding) which is intended to capture the semantic and syntactic meaning of input text. S225 may comprise inputting the text label of each UI input field to the embedding model and receiving a multi-dimensional vector associated with the UI input field in return.

Next, at S230, a vector database is populated with the mappings. Moreover, each mapping is associated with an embedding of the UI input field of the mapping. As will be described below, this association may provide fast identification of mappings which relate to a given UI input field for which a binding is to be determined.

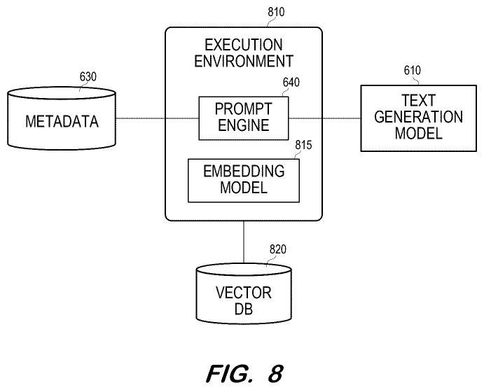

FIG. 8 illustrates a system to generate a vector database of mappings between database object fields and UI input fields according to some embodiments. Execution environment 810 includes prompt engine 640 for prompting text generation model 610 based on metadata 630 as described with respect to S220 and FIG. 6. Execution environment 810 also includes embedding model 815 to generate an embedding for each UI input field of the mappings returned by text generation model 610. Embedding model 815 may be implemented by executable program code, a set of hyperparameters defining a model structure and a set of corresponding weights, or any other representation of an input-to-output mapping.

FIG. 8 also depicts vector database 820. Vector database 820 stores a record for each mapping returned by text generation model 610. Each record is also associated with an embedding of the UI input field of the record. Vector database 820 may be designed to store, manage, and query vector embeddings. Examples of vector database 820 include but are not limited to Redis, ElasticSearch, and Pinecone.

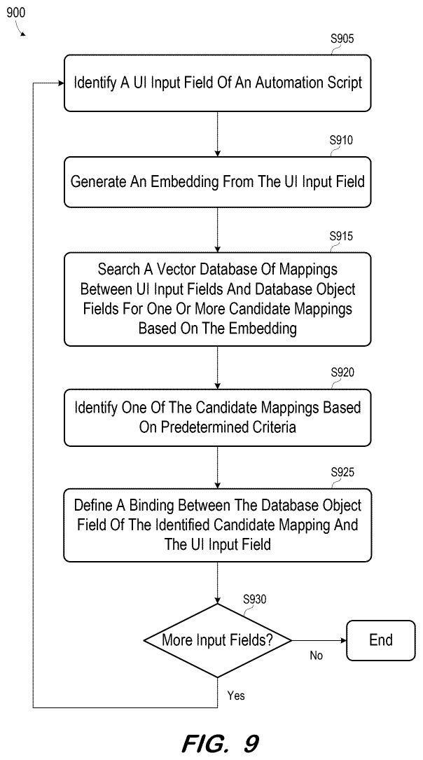

FIG. 9 is a flow diagram of process 900 to determine bindings between database object fields and UI input fields based on a vector database according to some embodiments. Process 900 may be executed during development of a test process. In this regard, it is assumed that a test automation script has been generated as described above prior to process 900. The test automation script specifies one or more UI input fields into which a data value was entered during recording of the test automation script.

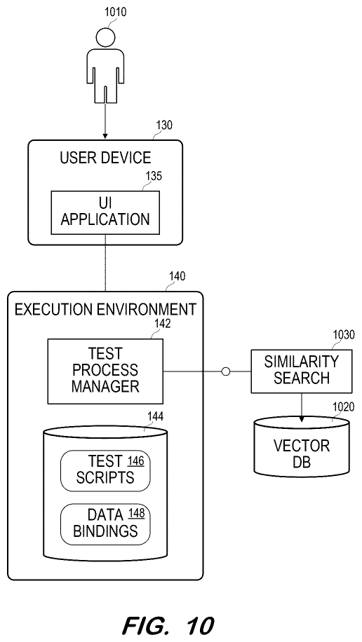

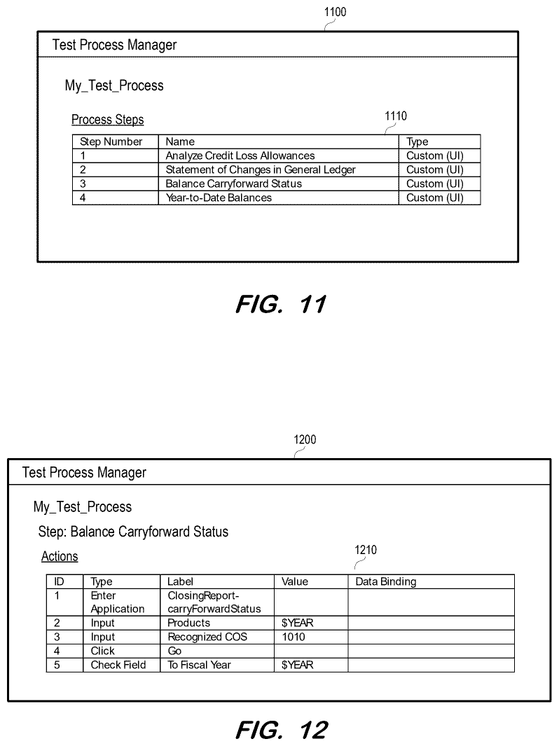

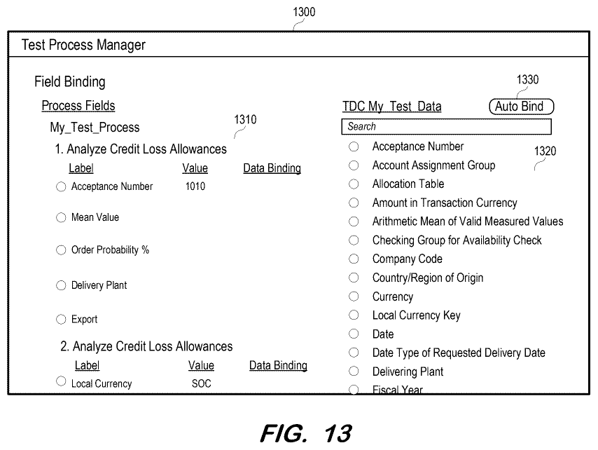

FIG. 10 illustrates a system to determine bindings between database object fields and UI input fields according to some embodiments of process 900. Data storage system 144 stores existing test scripts 146 which define test processes. User 1010 may operate UI application 135 of user device 130 to view a test script 146 on a UI of test process manager application 142. For example, UI 1100 of FIG. 11 lists process steps 1110 of a stored test script named My_Test_Process. FIG. 12 further shows UI 1200, which lists actions 1210 which comprise the step Balance Carryforward Status shown in FIG. 11. As shown in FIG. 12, actions 2 and 3 of the step Balance Carryforward Status consist of entries of values into UI input fields labeled Products and Recognized COS, respectively.

FIG. 13 depicts user interface 1300 for binding UI input fields of a process step with database object fields. Area 1310 of interface 1300 lists the UI input fields of each process step of My_Test_Process and area 1320 lists database object fields of test data container My_Test_Data. According to some embodiments, selection of Auto Bind control 1330 may initiate process 900 to determine bindings between the UI input fields of area 1310 and respective database object fields of area 1320.

In response to selection of Auto Bind control 1330, a UI input field of the subject automation script is identified at S905. With respect to the FIG. 13, the UI input field labeled “Acceptance number” may be identified at S905. Next, at S910, an embedding is generated from the identified UI input field. The label of the UI input field may be input to an embedding model (e.g., the embedding model used at S225) to generate the embedding at S910.

A vector database is searched at S915 based on the embedding. As described with respect to vector database 820, the vector database may include mappings between UI input fields and database object fields, with each mapping being associated with an embedding. Accordingly, S915 may comprise searching for a plurality of embeddings of the vector database which are most similar to the embedding generated at S910, and identifying the mappings associated with the plurality of embeddings.

Test process manager 142 may call similarity search component 1030 of FIG. 10 at S915 to search the embeddings stored in vector database 1020. Similarity search component 1030 may determine similarities based on a cosine similarity metric or on any other suitable metric representing a degree of similarity between embeddings. The mappings identified at S915 may be referred to as candidate mappings.

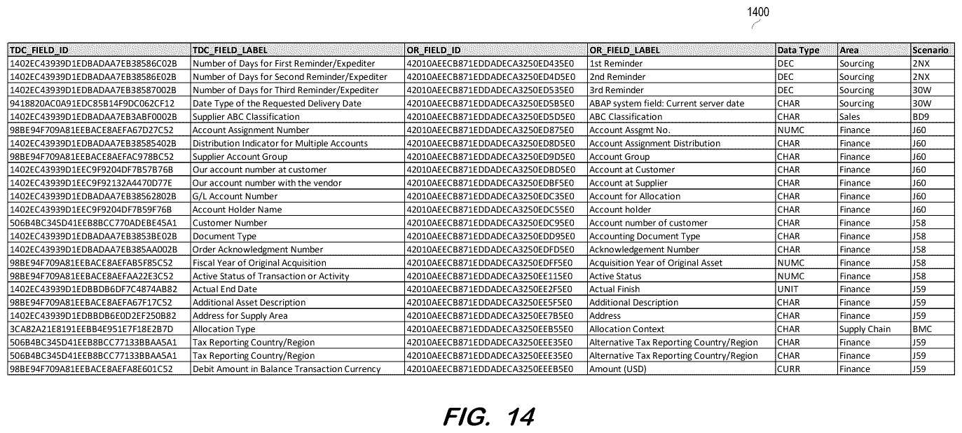

One of the candidate mappings is identified at S920 based on predetermined criteria. FIG. 14 illustrates several mappings of a vector database according to some embodiments. As shown, each mapping of the vector database may be associated with metadata such as a data type, an enterprise area and an enterprise scenario associated with the database object field of the mapping. Identification of one of the candidate mappings at S920 may therefore consider the database object fields of the candidate mappings as well as the additional metadata associated with the mappings. For example, S920 may comprise determination of one of the candidate mappings whose data type, enterprise area and enterprise scenario most closely match the data type, enterprise area and enterprise scenario of the UI input field identified at S905.

According to some embodiments, the identification at S920 may incorporate logic similar to that described with respect to process 700. Specifically, S920 may consist of determining one of the candidate mappings based on, in decreasing order of importance, similarities between the names of the database object fields and the name of the UI input field, compatibility of the data types of the database object fields with the data type of the UI input field, semantic similarities between the names of the database object fields and the name of the UI input field, similarities between the enterprise areas and enterprise scenarios of the database object fields and the enterprise area and enterprise scenario of the UI input field, and on localizations or translations of common terms.

A binding between the database object field of the identified candidate mapping and the UI input field is defined at S925. Flow then proceeds to S930 to determine whether additional UI input fields remain to be bound to respective database object fields. If so, flow returns to S905 and continues as described above with respect to another UI input field. Flow terminates once it is determined that no more UI input fields of the test script remain to be bound.

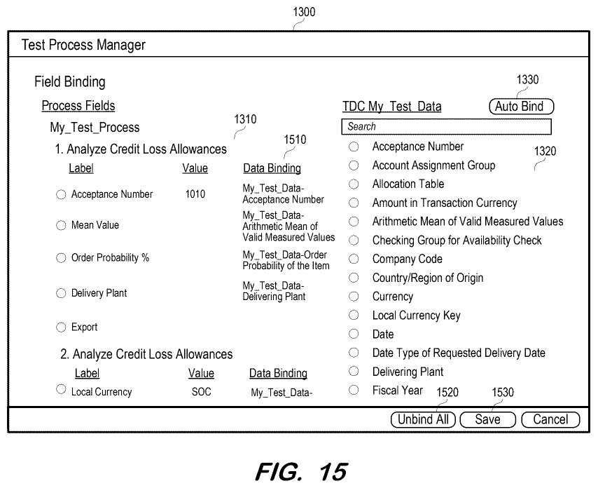

FIG. 15 illustrates user interface 1500 of a test process manager application showing bindings 1510 between UI input fields 1310 and database object fields 1320 which were defined at S925 according to some embodiments. Each binding 1510 indicates a database object field to which the associated UI input field 1510 is bound. Selection of Unbind All control 1520 deletes bindings 1510, while Save control 1530 may be selected to cause storage of bindings 1510 in data bindings 148. Data bindings 148 may then be used as described above to identify values of test data container My_Test_Data for populating UI input fields during execution of the test script My_Test_Process.

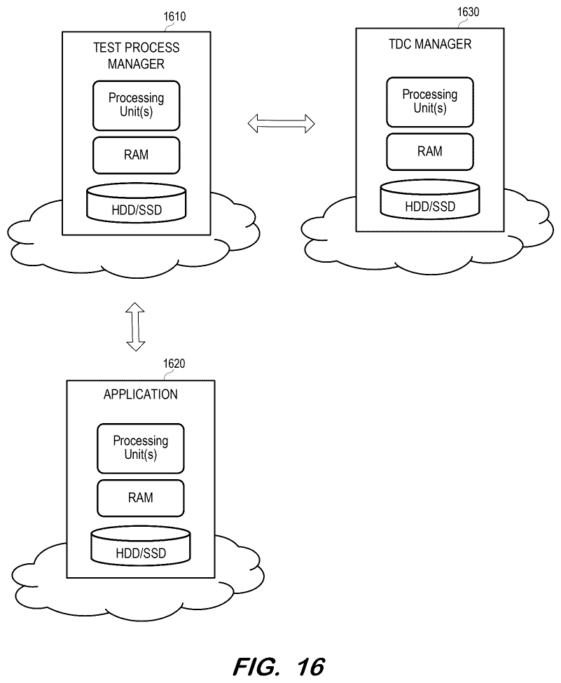

FIG. 16 is a diagram of a cloud-based implementation according to some embodiments. Generally, test process manager 1610 may execute test automation scripts against application 1620 using bindings generated as described herein and test data containers defined by test data container manager 1630. Each of systems 1610 through 1630 may comprise cloud-based resources residing in one or more public clouds providing self-service and immediate provisioning, autoscaling, security, compliance and identity management features. Each of systems 1610 through 1630 may comprise servers or virtual machines of respective Kubernetes clusters, but embodiments are not limited thereto.

The foregoing diagrams represent logical architectures for describing processes according to some embodiments, and actual implementations may include more, or different components arranged in other manners. Other topologies may be used in conjunction with other embodiments. Moreover, each component or device described herein may be implemented by any number of devices in communication via any number of other public and/or private networks. Two or more of such computing devices may be located remote from one another and may communicate with one another via any known manner of network(s) and/or a dedicated connection. Each component or device may comprise any number of hardware and/or software elements suitable to provide the functions described herein as well as any other functions. For example, any computing device used in an implementation of a system according to some embodiments may include a processor to execute program code such that the computing device operates as described herein.

All systems and processes discussed herein may be embodied in program code stored on one or more non-transitory computer-readable recording media. Such media may include, for example, a hard disk, a DVD-ROM, a Flash drive, magnetic tape, and solid-state Random Access Memory (RAM) or Read Only Memory (ROM) storage units. Embodiments are therefore not limited to any specific combination of hardware and software.

Embodiments described herein are solely for the purpose of illustration. Those in the art will recognize other embodiments may be practiced with modifications and alterations to that described above.

1. A system comprising:
a memory storing program code; and
at least one processing unit to execute the program code to cause the system to:
responsive to receiving a plurality of automation scripts, perform, for the plurality of automation scripts:
determine input fields of the plurality of automation scripts;
acquire metadata of database object fields;
prompt a text generation model using a chain-of-thoughts prompt, the input fields and the acquired metadata to determine mappings between the input fields and the database object fields;
prompt an embedding model to generate embeddings based on each input field, each embedding comprising a multi-dimensional numerical vector;
store the embeddings in a vector database; and
for each stored embedding, associate the embedding with each mapping including the input field based on which the embedding was generated;
responsive to receiving a first automation script, after storing the embeddings in the vector database:
identify a first input field of the first automation script;
prompt the embedding model to generate a first embedding based on the first input field;
search the vector database for one or more embeddings similar to the first embedding;
identify a candidate mapping associated with each of the one or more embeddings; and
determine a first database object field to bind to the first input field of the first automation script based on the identified candidate mappings.

2. The system of claim 1, the at least one processing unit to execute the program code to cause the system to:
identify a second input field of the first automation script;
prompt the embedding model to generate a second embedding based on the second input field;
search the vector database for a second one or more embeddings similar to the second embedding;
identify a second candidate mapping associated with each of the second one or more embeddings; and
determine a second database object field to bind to the second input field based on the identified second candidate mappings.

3. The system of claim 2, the at least one processing unit to execute the program code to cause the system to:
identify a third input field of a second automation script;
prompt the embedding model to generate a third embedding based on the third input field;
search the vector database for a third one or more embeddings similar to the third embedding;
identify a third candidate mapping associated with each of the third one or more embeddings; and
determine a third database object field to bind to the third input field based on the identified third candidate mappings.

4. The system of claim 1, the at least one processing unit to execute the program code to cause the system to:
identify a second input field of a second automation script;
prompt the embedding model to generate a second embedding based on the second input field;
search the vector database for a second one or more embeddings similar to the second embedding;
identify a second candidate mapping associated with each of the second one or more embeddings; and
determine a second database object field to bind to the second input field based on the identified second candidate mappings.

5. The system of claim 4, where the plurality of automation scripts do not include the first automation script or the second automation script.

6. The system of claim 1, where the plurality of automation scripts do not include the first automation script.

7. The system of claim 1, the at least one processing unit to execute the program code to cause the system to:
determine document object model properties of the determined input fields,
wherein the text generation model is prompted using a chain-of-thoughts prompt, the input fields, the document object model properties and the acquired metadata to determine mappings between the input fields and the database object fields.

8. A method comprising:
responsive to receiving a plurality of automation scripts, performing, for the plurality of automation scripts:
determining input fields of the plurality of automation scripts;
acquiring metadata of database object fields;
prompting a text generation model using a chain-of-thoughts prompt, the input fields and the acquired metadata to determine mappings between the input fields and the database object fields;
prompting an embedding model to generate embeddings based on each input field, each embedding comprising a multi-dimensional numerical vector;
storing the embeddings in a vector database; and
for each stored embedding, associating the embedding with each mapping that includes the input field based on which the embedding was generated;
responsive to receiving a first automation script, after storing the embeddings in the vector database:
identifying a first input field of the first automation script;
prompting a second embedding model to generate a first embedding based on the first input field;
searching the vector database for one or more embeddings similar to the first embedding;
identifying a candidate mapping associated with each of the one or more embeddings; and
determining a first database object field to bind to the first input field of the first automation script based on the identified candidate mappings.

9. The method of claim 8, further comprising:
identifying a second input field of the first automation script;
prompting the second embedding model to generate a second embedding based on the second input field;
searching the vector database for a second one or more embeddings similar to the second embedding;
identifying a second candidate mapping associated with each of the second one or more embeddings; and
determining a second database object field to bind to the second input field based on the identified second candidate mappings.

10. The method of claim 9, further comprising:
identifying a third input field of a second automation script;
prompting the second embedding model to generate a third embedding based on the third input field;
searching the vector database for a third one or more embeddings similar to the third embedding;
identifying a third candidate mapping associated with each of the third one or more embeddings; and
determining a third database object field to bind to the third input field based on the identified third candidate mappings.

11. The method of claim 8, further comprising:
identifying a second input field of a second automation script;
prompting the second embedding model to generate a second embedding based on the second input field;
searching the vector database for a second one or more embeddings similar to the second embedding;
identifying a second candidate mapping associated with each of the second one or more embeddings; and
determining a second database object field to bind to the second input field based on the identified second candidate mappings.

12. The method of claim 11, where the plurality of automation scripts do not include the first automation script or the second automation script.

13. The method of claim 8, where the plurality of automation scripts do not include the first automation script.

14. The method of claim 8, further comprising:
determining document object model properties of the determined input fields, wherein the text generation model is prompted using a chain-of-thoughts prompt, the input fields, the document object model properties and the acquired metadata to determine mappings between the input fields and the database object fields.

15. One or more non-transitory computer-readable media storing program code, the program code executable by at least one processing unit of a computing system to cause the computing system to perform operations comprising:
responsive to receiving a plurality of automation scripts, performing, for the plurality of automation scripts:
determining input fields of the plurality of automation scripts;
acquiring metadata of database object fields;
prompting a text generation model using a chain-of-thoughts prompt, the input fields and the acquired metadata to determine mappings between the input fields and the database object fields;
prompting an embedding model to generate embeddings based on each input field, each embedding comprising a multi-dimensional numerical vector;
storing the embeddings in a vector database; and
for each stored embedding, associating the embedding with each mapping that includes the input field based on which the embedding was generated;
responsive to receiving a first automation script, after storing the embeddings in the vector database:
identifying a first input field of the first automation script;
prompting a second embedding model to generate a first embedding based on the first input field;
searching the vector database for one or more embeddings similar to the first embedding;
identifying a candidate mapping associated with each of the one or more embeddings; and
determining a first database object field to bind to the first input field of the first automation script based on the identified candidate mappings.

16. The one or more non-transitory computer-readable media of claim 15, the operations further comprising:
identifying a second input field of the first automation script;
prompting the second embedding model to generate a second embedding based on the second input field;
searching the vector database for a second one or more embeddings similar to the second embedding;
identifying a second candidate mapping associated with each of the second one or more embeddings; and
determining a second database object field to bind to the second input field based on the identified second candidate mappings.

17. The one or more non-transitory computer-readable media of claim 16, the operations further comprising:
identifying a third input field of a second automation script;
prompting the second embedding model to generate a third embedding based on the third input field;
searching the vector database for a third one or more embeddings similar to the third embedding;
identifying a third candidate mapping associated with each of the third one or more embeddings; and
determining a third database object field to bind to the third input field based on the identified third candidate mappings.

18. The one or more non-transitory computer-readable media of claim 15, the operations further comprising:
identifying a second input field of a second automation script;
prompting the second embedding model to generate a second embedding based on the second input field;
searching the vector database for a second one or more embeddings similar to the second embedding;
identifying a second candidate mapping associated with each of the second one or more embeddings; and
determining a second database object field to bind to the second input field based on the identified second candidate mappings.

19. The one or more non-transitory computer-readable media of claim 18, where the plurality of automation scripts do not include the first automation script or the second automation script.

20. The one or more non-transitory computer-readable media of claim 15, the operations further comprising:
determining document object model properties of the determined input fields,
wherein the text generation model is prompted using a chain-of-thoughts prompt, the input fields, the document object model properties and the acquired metadata to determine mappings between the input fields and the database object fields.
